(19) United States
(12) Patent Application Publication
(10) Pub. No.: US 2026/0227614 A1
(43) Pub. Date: Aug. 6, 2026

(54) IMAGING SYSTEM WITH PHOTON REALLOCATION

(71) Applicants: CENTRE NATIONAL DE LA RECHERCHE SCIENTIFIQUE, PARIS (FR); UNIVERSITE DE LIMOGES, LIMOGES (FR)

(72) Inventors: Pierre BON, LIMOGES (FR); Alberto AGUILAR, LIMOGES (FR)

(73) Assignees: CENTRE NATIONAL DE LA RECHERCHE SCIENTIFIQUE, PARIS (FR); UNIVERSITE DE LIMOGES, LIMOGES (FR)

(21) Appl. No.: 19/148,355

(22) PCT Filed: Dec. 22, 2023
(86) PCT No.: PCT/EP2023/087698

§ 371 Date: Jul. 16, 2025

(30) Foreign Application Priority Data
Jan. 20, 2023 (FR) FR2300550

(51) Int. Cl. G02B 21/00

(52) U.S. Cl. CPC G02B 21/0064; G02B 21/0032; G02B 21/0048; G02B 21/006; G02B 21/008

(57) ABSTRACT

A photon-reallocation imaging system includes a polychromatic light source (SL) for generating an illumination light beam (FE); a first optical system (SO1) dispersing said illumination light beam with a first angular dispersion DA1 and focusing it on a sample (E) to form a first spectral line (LS1); a second optical system (SO2) collecting a light beam (FS) elastically scattered by the sample to apply thereto a second angular dispersion DA2 and to focus it in a focal plane so as to form a second spectral line (LS2) with a length greater than that of the first spectral line; a matrix image sensor (CMI) arranged in the image focal plane; —a mechanism (S1) for inducing a relative displacement between the first spectral line and the sample in a third direction (y), perpendicular to the first direction; and a mechanism for forming an image of the sample through photon reallocation.

### FIELD

The invention relates to the field of optical microscopy, and more generally of imaging.

### BACKGROUND

Optical microscopy plays an essential role in biology and in micro- and nanotechnologies, as it allows samples to be observed at high speed unlike, for example, electron microscopy which requires complex preparation operations. However, its resolving power is necessarily limited by the diffraction of light. In accordance with Abbe's theory, for a conventional optical microscope, the maximum resolution d is given by

$$d = \frac{λ}{2 ON}$$

where λ is the wavelength of the light used (between 380 nm and 780 nm for visible light) and ON the numerical aperture which can hardly exceed a value of 1.4 for biological samples. As a result, the resolution of visible light cannot exceed 135 nm, which is not suitable for observing very small structures such as viral particles. Spatial resolution can also be improved by reducing the wavelength, but at the cost of considerable technical difficulties.

So-called “super-resolution” techniques make it possible to exceed the Abbe diffraction limit by using fluorescent markers and/or non-linear effects. These techniques are complex to implement and not suitable for all applications.

Moreover, in biology as well as in micro- and nanotechnologies, it is often necessary to also achieve high spatial resolution in an axial direction (the Abbe limit relates to lateral resolution, in a plane perpendicular to the optical axis). Confocal microscopy makes it possible to obtain images with a very shallow depth of field (of the order of a few hundred nanometers), and therefore to “section” the sample to gain access to its three-dimensional structure. This technique is most often associated with the use of fluorescent markers, but it can also be used in reflectance, without markers.

A confocal microscope uses a point source of illumination, an image of which is projected onto the sample to be observed by means of an objective lens. The light coming from the sample (backscattered light in the case of a reflectance confocal microscope; fluorescent emission when a fluorescent marker is used) is focused on a pinhole optically conjugated to the point source, then detected by means of a photomultiplier, for example. The function of the pinhole is to eliminate the radiation that does not come from the focal plane of the objective lens, thus achieving optical sectioning. A point-by-point image of the sample is obtained by scanning. More precisely, a two-dimensional scan, in both directions perpendicular to the optical axis, provides an image of a slice of the sample centered around the focal plane of the objective lens. Adding an axial scan of this focal plane produces a three-dimensional image.

The smaller the pinhole diameter, the smaller the slice thickness, and therefore the better the axial resolution, but the gain is small below 1 Airy unit (AU). The Airy unit is the diameter of the microscope's Airy disk, and is

$$\frac{λ}{2 ON} .$$

Confocal microscopy allows a gain in lateral resolution, with respect to the Abbe limit, of up to 30% in theory, using a pinhole with a diameter of less than 1 AU. However, this is achieved at the cost of degrading the signal-to-noise ratio.

The photon reallocation technique, first proposed in (Sheppard 1988), can improve the lateral resolution of a confocal microscope by a factor of 2 in principle. The idea behind this technique is to replace the photomultiplier, or more generally the point radiation detector, with a matrix detector that acquires an elementary image for each acquisition point. The image is then resized (ideally reduced by a factor of 2) by digital or optical means before moving on to the next scan point. The final image is obtained by integrating the different scan images acquired in succession, each shifted by one scan step with respect to the previous image.

A purely optical implementation of the photon reallocation technique is described in (York 2013), (De Luca 2013) and (Curd 2015). It consists of applying a first angular scan to the illumination beam, applying a reverse angular scan to the beam coming from the sample, and then applying a second angular scan, synchronized with the first scan, to this same beam coming from the sample. The second angular scan has an amplitude normalized with respect to the beam cross-section that is greater, ideally by a factor of two, than the first scan. “Normalized with respect to the beam cross-section” means that if a is the ratio between the amplitude of the second angular scan to that of the first angular scan and M is the ratio between the cross-section of the beam coming from the sample to that of the light beam, it is the quantity a/M that must be greater than 1 and ideally equal to 2.

As with conventional confocal microscopy, acquisition can be parallelized using a pinhole array and microlens arrays see for example the aforementioned article (York 2013).

Photon reallocation has been applied in particular to confocal fluorescence microscopy, see for example the aforementioned articles (York 2013), (De Luca 2013) and (Curd 2015), where a gain in lateral resolution of a factor of 1.5 has been observed. To the best of the inventor's knowledge, the only reflectance application of photon reallocation has been described in (DuBose 2019). In this article, however, there was no mention of a microscope, but of an ophthalmoscope, wherein the objective lens is replaced by the crystalline lens of a patient's eye, thus presenting a small numerical aperture, and as a result, a resolution of the order of tens of micrometers.

Document EP 4012476 and the article (Aguilar 2020) describe a method and a confocal microscopy apparatus by reflectance or transmission with photon reallocation with a spatial resolution optimized by appropriate pinhole sizing.

Confocal microscopy with photon reallocation is a point-by-point scanning imaging technique. As a result, it requires long acquisition times which are detrimental, even prohibitive, for certain applications such as in-situ characterization in non-destructive testing for rapid diagnosis in the biomedical, materials and micro- and nanotechnology industries.

The invention aims to overcome this shortcoming of the prior art.

### SUMMARY

In accordance with the invention, this aim is achieved by dispersing a light beam in a first direction so as to form a “spectral line” which illuminates the sample. Thus, a plurality of points on the sample aligned in said first direction are illuminated simultaneously with different wavelengths. A portion of the surface of the sample can therefore be inspected by scanning solely in a second direction which is not parallel (and preferentially perpendicular) to the first.

The act of having to scan along a single direction instead of two significantly reduces image acquisition time. Additionally, in some embodiments of the invention, this allows the use of resonant mirrors oscillating at a very high frequency—of the order of several tens of kHz—which further reduces acquisition time. The use of such mirrors would be difficult to envisage if, in accordance with the prior art, two scans had to be synchronized along the first and the second direction.

The use of a spectral line to replace scanning in a spatial direction has already been proposed, for example in (Tearney 1998) and (Hwang 2015). More particularly, (Tearney 1998) relates to a fibered confocal microscope intended to be incorporated into an endoscope, while the microscope in (Hwang 2015) replaces scanning in the 2^{nd} direction with spatially variable frequency modulation. None of these systems can exceed the Abbe limit, and in particular are not compatible with the principle of photon reallocation.

One object of the invention is therefore a photon-reallocation imaging system comprising:
A polychromatic light source configured to generate at least one spatially coherent illumination light beam over a range of illumination wavelengths;
A first optical system configured to disperse said illumination light beam with a first angular dispersion DA₁ and to focus it on a sample so as to form a first spectral line oriented in a first direction;
A second optical system configured to collect a light beam elastically scattered by said sample, referred to as signal beam, to apply thereto a second angular dispersion DA₂, and to focus it in a focal plane so as to form a second spectral line oriented in a second direction;
A matrix image sensor arranged in said image focal plane;
A means for inducing a relative displacement between the first spectral line and the sample in a third direction, perpendicular to the first direction; and
A means for forming an image of the sample through photon reallocation based on one or more images acquired by said matrix image sensor in correspondence with a plurality of different positions adopted by the first spectral line on the sample;
wherein the first optical system comprises a first dispersive optical device for dispersing said illumination light beam with a first angular dispersion DA₁ and the second optical system comprises a second dispersive optical device for applying to said illumination light beam with said second angular dispersion DA₂;
the length of the second spectral line in the second direction being greater than that of the first spectral line in the first direction by a factor A_{G}=M_{G}DA₂/DA₁>1, M_{G} being the ratio of the light beam size on the first dispersive optical device measured in the first direction to the signal beam size on the second dispersive optical device measured in the second direction.

According to specific embodiments of the invention:

Said factor AG can be between 1.8 and 2.2.

The first optical system may comprise:
a first collimator system, configured to collimate said illumination light beam;
said first dispersive optical device;
a focusing optical system configured to receive as input the illumination light beam dispersed by said first dispersive device and to focus it on the sample.

The second optical system may comprise:
said or another focusing system for collecting said signal beam, collimating it and directing it to said first dispersive optical device, or another dispersive optical device, such that it is spectrally recombined;
said first or said other dispersive optical device, configured to spectrally recombine said signal beam;
said second dispersive optical device having the second angular dispersion DA₂, for spectrally dispersing said signal beam in said second direction; and
at least one optical element configured to focus in a focal plane, referred to as image focal plane, the signal beam spectrally dispersed by the second dispersive optical device.

In this case, the second optical system may comprise a pinhole arranged in a plane conjugate with a focal plane of the focusing system of the second optical system so as to perform confocal filtering.

The means for forming an image of the sample through photon reallocation based on a plurality of images of the second spectral line acquired by said matrix image sensor may comprise a digital image processor. In this case, the means for inducing a relative displacement between the first spectral line and the sample may comprise a sample translation stage, or else it may comprise a variable orientation mirror common to the first and to the second optical system, configured to apply an angular scan in the third direction to the illumination light beam and an opposite angular scan to the spectrally recombined signal beam.

According to other embodiments
The means for inducing a relative displacement between the first spectral line and the sample may comprise a first variable orientation mirror common to the first and to the second optical system, configured to apply an angular scan in the third direction to the illumination light beam and an opposite angular scan to the spectrally recombined signal beam; and
The means for forming an image of the sample through photon reallocation comprises a second variable orientation mirror, configured to apply an angular scan in a fourth direction, perpendicular to the second direction, to the signal beam spectrally dispersed by the second dispersive optical device;

The angular scan applied by the second variable orientation mirror being synchronous and having an amplitude equal to A_{S}/M_{S} times the amplitude of that applied by the first mirror, A_{S} being a factor of between 1.8 and 2.2 and M_{S} being the ratio between the dimension of the illumination light beam on the second variable orientation mirror, measured in the fourth direction, and the dimension of the spectrally dispersed signal beam on the first variable orientation mirror, measured in the third direction. In this case, the first variable orientation mirror can be structurally independent of the second variable orientation mirror, and the first dispersive optical device is separate from the second dispersive optical device.

The first dispersive optical device may be a diffractive system having said angular dispersion DA₁ at the first diffraction order and said angular dispersion DA₂=2DA₁ at the second diffraction order, the second optical system being configured to collect the light scattered at the second diffraction order by said diffractive system.

In other embodiments, the first and the second variable orientation mirrors can be formed by two separate reflective regions of the same variable orientation support. For example, said orientation support. The first dispersive optical device may be separate from the second dispersive optical device.

The light source may comprise a first set of a plurality of microlenses aligned in the third direction to generate a plurality of said illumination light beams in parallel, whereby said first optical system forms on the sample a plurality of first spectral lines oriented in a first direction and arranged in said third direction, and wherein said second optical system may comprise a second set of a plurality of microlenses aligned in said third direction to form on the matrix image sensor a plurality of first spectral lines oriented in a first direction and arranged in a fourth direction, perpendicular to said second direction.

It should be noted that, contrary to what is taught for example by (Tearney 1998) and (Hwang 2015), an imaging system according to the invention performs a second spatial dispersion operation to form, on the image sensor, a second spectral line of greater length (ideally double) than that of the first spectral line projected onto the sample. This is necessary to make photon reallocation possible.

### BRIEF DESCRIPTION OF THE FIGURES

Further features, details and advantages of the invention will become apparent upon reading the description made with reference to the appended figures given by way of example and which show, respectively:

FIG. 1, a schematic diagram of a confocal microscope with photon reallocation according to a first embodiment of the invention;

FIG. 2, a schematic diagram of a confocal microscope with photon reallocation according to a second embodiment of the invention;

FIG. 3, a schematic diagram of a confocal microscope with photon reallocation according to a third embodiment of the invention;

FIG. 4 a schematic diagram of a confocal microscope with photon reallocation according to a fourth embodiment of the invention;

FIG. 5, a schematic diagram of a confocal microscope with photon reallocation according to a fifth embodiment of the invention;

FIG. 6, a schematic diagram of a confocal microscope with photon reallocation according to a sixth embodiment of the invention; and

FIG. 7, a schematic diagram of a confocal microscope with photon reallocation according to a seventh embodiment of the invention

FIG. 8, a schematic diagram of a confocal microscope with photon reallocation according to an eighth embodiment of the invention.

### DETAILED DESCRIPTION

In the figures, the same reference signs designate corresponding elements.

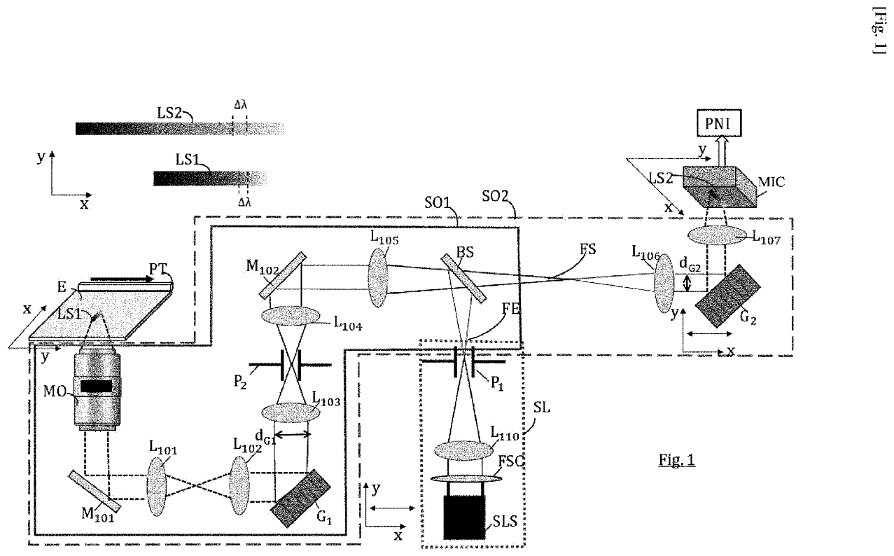

In the device shown in [FIG. 1], a polychromatic light source SL generates a spatially—but generally not temporally—coherent light beam FE. The source SL comprises for example a broad-spectrum source SLS, for example an arc lamp, a light-emitting diode or a pulsed laser. A spectral filter FSC selects a portion of the spectrum of the source SLS. The extent of the wavelength range selected by the filter FSC determines, with the angular dispersion DA₁, the extent of the first spectral line scanning the sample. Its sizing is the result of a compromise—a wide spectral extent reduces constraints on the angular dispersion DA₁ and allows a greater fraction of the total light intensity emitted by the source SLS to be taken advantage of, but makes it more difficult to compensate for chromatic aberrations in the imaging system (axial and longitudinal chromatism) especially with an f-theta scan lens that typically tolerates a spectral width αλ/λ of the order of 10%. The resolution across the field of view also becomes variable in the case of large spectral ranges (optical resolution proportional to the local wavelength).

A converging lens L₁₁₀ and a pinhole P₁ arranged in the focal plane of this latter perform spectral filtering to ensure the spatial coherence of the light beam FE.

The light beam FE exiting the light source SL is reflected by a beam splitter BS which directs it towards the first optical system SO1, intended to illuminate the sample E. Said optical system SO1 comprises, in addition to the beam splitter BS, a first converging lens L₁₀₅ which collimates the beam FE; a planar mirror M₁₀₂ (not essential), two other converging lenses L₁₀₄, L₁₀₃ forming an afocal system, in the common focal plane of which is arranged a second pinhole P₂, which is thus optically conjugated with the first pinhole P₁ at the output of the light source SL. The light beam exits the collimated lens L₁₀₃ and is directed towards a diffraction grating G₁ having an angular dispersion DA₁ in a first direction x. The beam diffracted by the grating G₁ passes through an afocal system consisting of two further converging lenses L₁₀₁, L₁₀₂ and is reflected by a planar mirror M₁₀₂ (not essential) before being focused on the sample E by a microscope objective lens MO. Spectral dispersion by the grating G₁ and focusing by the objective lens MO result in the formation of a spectral line LS1 on the sample, that is, an elongated focal spot oriented in direction x, wherein the wavelength of the light varies monotonically with the position in said direction x.

The main function of the afocal system formed by the lenses L₁₀₁ and L₁₀₂ is to systematically place the diffraction grating G₁ in a plane conjugate to the pupil of the microscope objective lens, located at the rear of the microscope. Additionally, it can be used to adjust the size of the light beam.

The sample E is mounted on a translation stage PT which allows it to be translated in a direction y perpendicular to x. In this fashion, the spectral line LS1 scans one surface of the sample.

A second optical system SO2 collects the light beam FS (“signal beam”) elastically scattered by the sample—that is, scattered without a change in wavelength—to form a second spectral line LS2 on a matrix image sensor CMI. The imaging system shown in [FIG. 1] operates in reflection mode, which allows optical elements to be shared between the first and the second optical system. More particularly, all the elements of the first optical system SO1 also belong to the second optical system, which also comprises additional components. Also, the light backscattered by the sample E is collected and collimated by the microscope objective lens MO and spectrally recombined by the same diffraction grating G₁ that had dispersed it on the outward path. The afocal system formed by the lenses L₁₀₃ and L₁₀₄ allows confocal filtering to be performed, as in a confocal microscope according to the prior art, as well as the size of the beam FS to be modified.

The beam FS passes through the beam splitter BS which had reflected the light beam FE from the source SL. The converging lenses L₁₀₅ and L₁₀₆, placed on both sides of said beam splitter, form an afocal system which allows a second diffraction grating G₂ to be placed in a plane conjugate to the pupil of the objective lens MO. This second diffraction grating again disperses light in direction x. A lens L₁₀₇ forms a second spectral line LS2 oriented in direction x on the matrix image sensor CMI.

The matrix image sensor can be produced, for example, with CMOS or CCD technology. It has a number of pixels in direction x which is determined by the spatial extent of the spectral line obtainable by the optical system SO2, typically in the hundreds. The number of pixels in direction y may be smaller—of the order of ten or of a few dozen—as these pixels are used solely to implement a photon reallocation algorithm by a digital image processor PNI. To implement this algorithm, the digital image processor PNI must be synchronized with the translation stage. The digital image processor PNI can be for example a suitably programmed microprocessor or a dedicated digital circuit.

For this algorithm to achieve improved spatial resolution, the second spectral line LS2 must be longer in direction x, ideally by a factor of 2 or close to 2 (for example between 1.8 and 2.2). This is exemplified in the top-left part of the figure; it can notably be seen that a segment corresponding to a wavelength interval Δλ is longer in the spectral line LS2 than in LS1. This elongation can be achieved by virtue of using a second diffraction grating G₂ with an angular dispersion DA₂ greater than that—DA₁—of the first diffraction grating, by virtue of the magnification M_{G} of the optical beam produced by the assembly of lenses L₁₀₃, L₁₀₄, L₁₀₅ and L₀₀₆, or by a combination of both. Generally speaking, if M_{G} is the ratio between the diameter d_{G2} of the beam incident on the grating G₂ and the diameter d_{G1} of the beam incident on the grating G₁ (M_{G}=d_{G2}/d_{G1}), we obtain M_{G}DA₂/DA₁=length (LS2)/length (LS1)=A_{G}, A_{G} being a factor between 1.8 and 2.2 and ideally having a value of 2. For example, if M_{G}=1, a second diffraction grating with (approximately) twice the angular dispersion of the first diffraction grating would be selected.

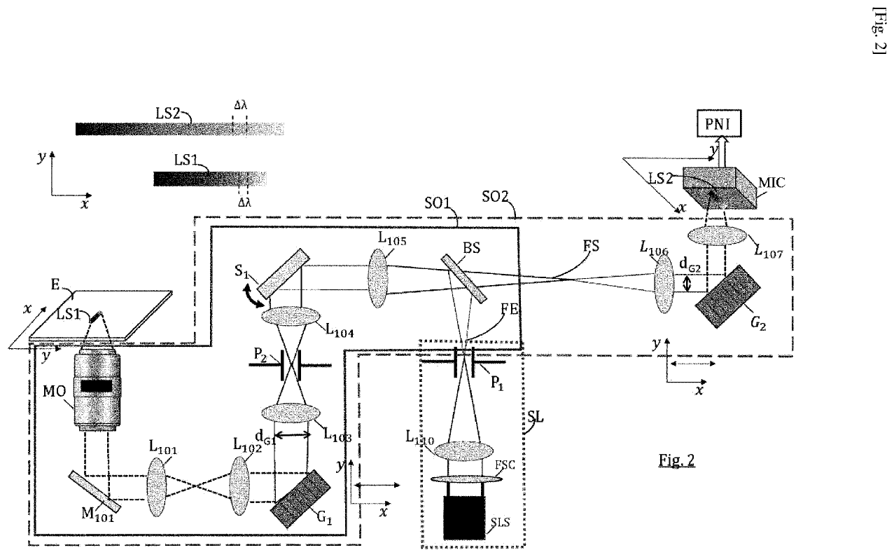

The embodiment shown in [FIG. 2] differs from that shown in [FIG. 1] only in that the mirror M₁₀₂ of the first optical system is replaced by an oscillating mirror—or more generally having a variable orientation—S₁. More precisely, the variation in orientation of the mirror S₁ is controlled so as to induce a displacement of the first spectral line LS1 on sample E in direction y; for this reason, S₁ will be referred to in the following as the “scanning mirror”. In this fashion, the spectral line LS1 scans the sample E without the need to translate it along direction y. As in the embodiment shown in [FIG. 1], photon reallocation is performed digitally by an image processor PNI, synchronized with the mobile mirror S₁.

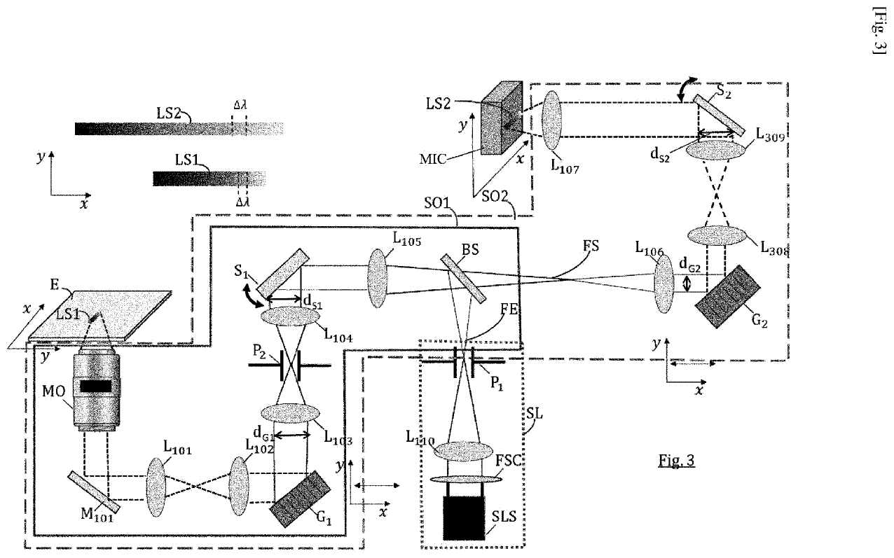

The embodiment shown in [FIG. 3] differs from that shown in [FIG. 2] in that the second optical system SO₂ also comprises an oscillating scanning mirror—or more generally having a variable orientation—S₂ arranged in front of the lens L₁₀₇ for focusing the beam FS on the matrix image sensor CMI. An afocal system formed by the converging lenses L₃₀₈ and L₃₀₉ allows the mirror S₂ to be conjugated with the pupil of the microscope objective lens MO.

The variation in orientation of the mirror S₂ is controlled so as to induce a displacement of the second spectral line LS2 on the matrix image sensor in direction y, thus achieving purely optical photon reallocation. To achieve a higher resolution, this scan must be synchronized with the scan performed by the first spectral line LS1 on sample E, and have a higher amplitude by a factor A_{S}/M_{S}, A_{S} being a factor between 1.8 and 2.2 and ideally having a value of 2, and M_{S} being the ratio between the diameter d_{S2} of the beam on the mirror S₂ and the diameter dₛ₁ of the beam on the mirror S₁. In the embodiment shown in [FIG. 3], M_{G} is the total magnification of the assembly consisting of lenses L₁₀₃, L₁₀₄, L₁₀₅, L₁₀₆, L₃₀₈ and L₃₀₉.

Unlike in the case of the embodiments shown in [FIG. 1] and [FIG. 2], the number of pixels of the matrix image sensor CMI in direction y is determined by the amplitude of the scan performed by the second spectral line LS2, and is typically of the same order of magnitude as the number of pixels in direction y.

Additionally, if the scans performed by the scanning mirrors S₁ and S₂ are fast enough, the image sensor CMI does not necessarily need to acquire a separate image for each position of the spectral lines LS1 and LS2: a single image can correspond to several positions. In a borderline case, the acquisition of a single image may be sufficient, eliminating the need for synchronization between the scanning mirrors S₁, S₂ and the matrix image sensor.

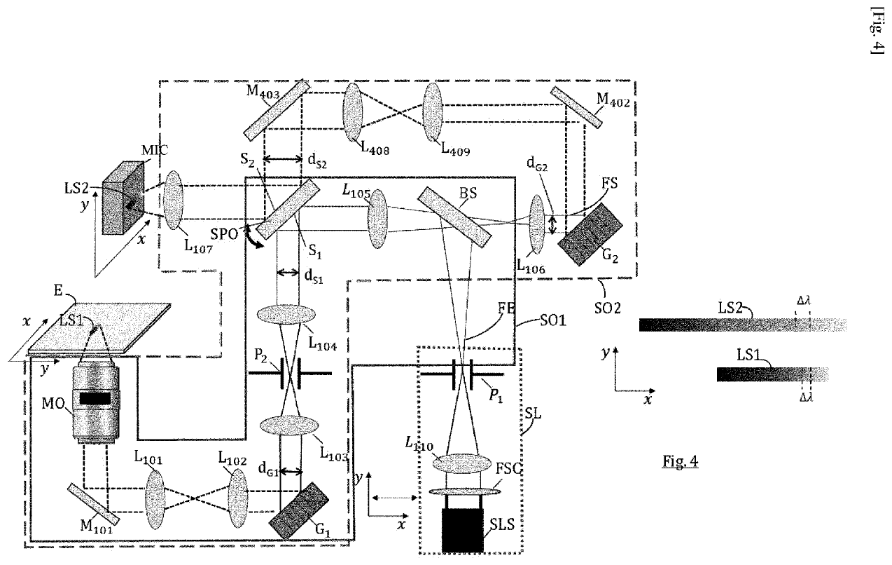

In the embodiments shown in [FIG. 1], [FIG. 2] and [FIG. 3], the scanning rate is limited by the need for synchronization: between the translation stage PT and the matrix image sensor CMI in the case of [FIG. 1]; between S₁ and the matrix image sensor CMI in the case of [FIG. 2]; and at least between S₁ and S₂ in the case of [FIG. 3]. This limitation can be overcome by virtue of the embodiment shown in [FIG. 4], wherein the two scanning mirrors S₁ and S₂ are produced on two opposite sides of the same oscillating, or more generally variable orientation, support, SPO. In the specific embodiment shown in the figure, this is made possible by the use of the two redirection mirrors M₄₀₂ and M₄₀₃. This eliminates any need in terms of synchronization, and therefore makes it much easier to use a high scanning frequency—in the kilohertz range—achieved, for example, by means of a resonant support SPO or a polygon scanner. Since the angular amplitude of the scan performed by the mirrors S₁ and S₂ is, by construction, the same, the second optical system must provide a magnification M_{S} of the beam FS between the two scanning mirrors of the order of 2 (in other words, d_{S2}/d_{S1}=M_{S}=A_{S}, with A_{S}=2—at least approximately). In the embodiment shown in [FIG. 4], this is achieved by the afocal system formed by the lenses L₁₀₅, L₁₀₆, L₄₀₈ and L₄₀₉.

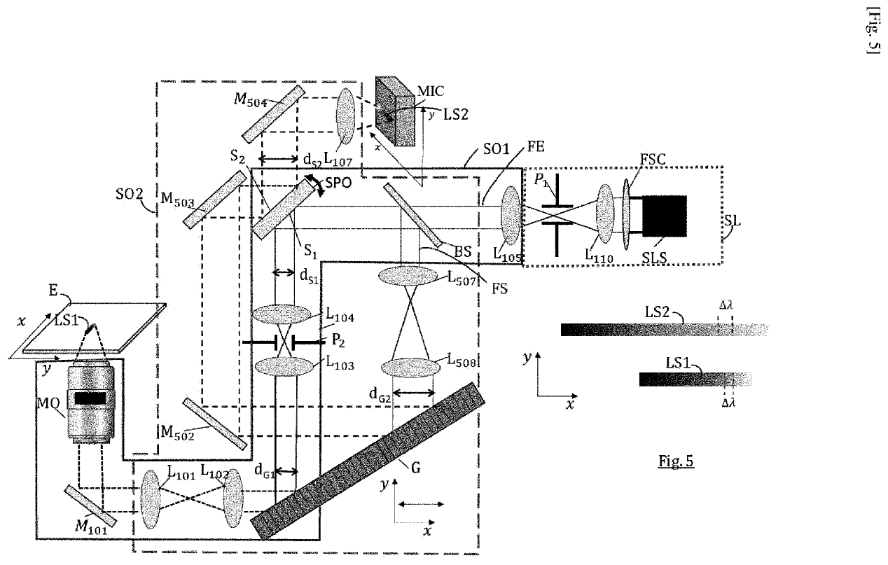

The embodiment shown in [FIG. 5] is similar to that shown in [FIG. 4], except that the functions of the two diffraction gratings G₁ and G₂ are performed by two separate regions of a single grating G, which is made possible by the use of redirection mirrors M₅₀₂, M₅₀₃ and M₅₀₄ and by the fact that, in the example shown in [FIG. 5], the light beam FE passes through the beam splitter BS, while the beam FS is reflected therefrom. Since the two separate gratings G₁ and G₂ are replaced by two areas of the same grating, DA₁=DA₂, the magnification M_{G} must be around 2, in other words d_{G2}=2d_{G1} at least approximately.

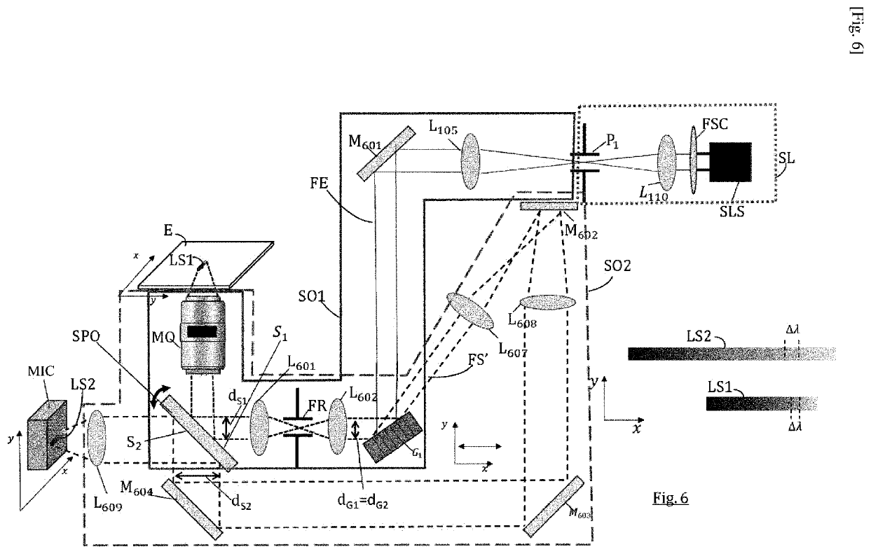

The embodiments shown in [FIG. 4] and [FIG. 5] require two diffraction gratings, or a single grating large enough to present two separate areas that can be illuminated independently of each other. The embodiment shown in [FIG. 6], on the other hand, comprises a single grating, the spatial extent of which need not necessarily be greater than that of the light beam FE.

The system shown in [FIG. 6] comprises a light source SL as described hereinbefore with reference to [FIG. 1]. The light beam FE from this source is collimated by the collimation lens L₁₀₅ of the light beam FE, is deflected by a first redirection mirror M₆₀₁ (not essential), and arrives on the diffraction grating G₁ which disperses it spectrally at the first diffraction order. The spectrally dispersed beam is spatially filtered by the slit FR located in the common focal plane of the two lenses L₆₀₁ and L₆₀₂ forming an afocal system. The length of the slit FR in the direction of spectral dispersion x depends on the angular dispersion introduced by the grating, while the width in direction y is determined as for the pinhole of a conventional confocal microscope. The main function of the afocal system formed by the lenses L₆₀₂ and L₁₀₅ is to optically conjugate the slit FR and the pinhole P₁ of the source SL. Alternatively, the slit FR can be omitted.

The spatially filtered light beam dispersed by the grating G₁ is directed towards the microscope objective MO by the scanning mirror S₁, formed by a reflecting surface of an oscillating or variable orientation support SPO, thereby obtaining a spectral line LS1 scanning the sample E, as described hereinbefore with reference to other embodiments. The light backscattered by the sample is collected by the objective lens MO, reflected by S₁, which compensates for the scanning effect introduced in the “outward path” and filtered spatially by the assembly L₆₀₁-FR-L602, before arriving again on the diffraction grating G₁. The originality of this embodiment is that, instead of collecting the beam spectrally recombined by the first diffraction order of the grating, which propagates along the path of the light beam but in the opposite direction, the second-order diffracted light (beam FS' in the figure) is used. As the second-order angular dispersion is double that of the first order, the diffracted beam FS' is not spectrally recombined, but has an angular dispersion of twice the amplitude of the first-order diffracted light beam FE (in other words, the spectral dispersion introduced on the “outward path” is over-compensated). This beam FS' is magnified by around a factor M_{S}=2 by the afocal system formed by the lenses L₆₀₇ and L₆₀₈ (also, d_{S2}=2dₛ₁), redirected (optionally) by the mirrors M₆₀₂, M₆₀₃, M₆₀₄, reflected by the scanning mirror S₂, formed on the same variable orientation support SPO as S₁ and finally focused by the lens L₆₀₉ to form the spectral line LS2 on the matrix image sensor CMI. By construction, in this embodiment d_{G1}=d_{G2}.

It should be noted that in the embodiments described hereinbefore, the first optical system SO1 for forming the first spectral line LS1 on the sample E and the second optical system coincide to a large extent, with the same optical components being traversed by light on the outward path (forming the first spectral line and illuminating the sample) and on the return path (collecting and processing the signal beam). More particularly, in the embodiments shown in [FIG. 1] to [FIG. 5], the first optical system is a subset of the second. This is less true in the case of the embodiment shown in [FIG. 6]: indeed, using the 2^{nd} order diffraction of the diffraction grating separates the path of the signal beam from that of the light beam. In other embodiments, the first and the second optical system may be totally or substantially disjoint. This is notably true of imaging systems operating in transmission mode.

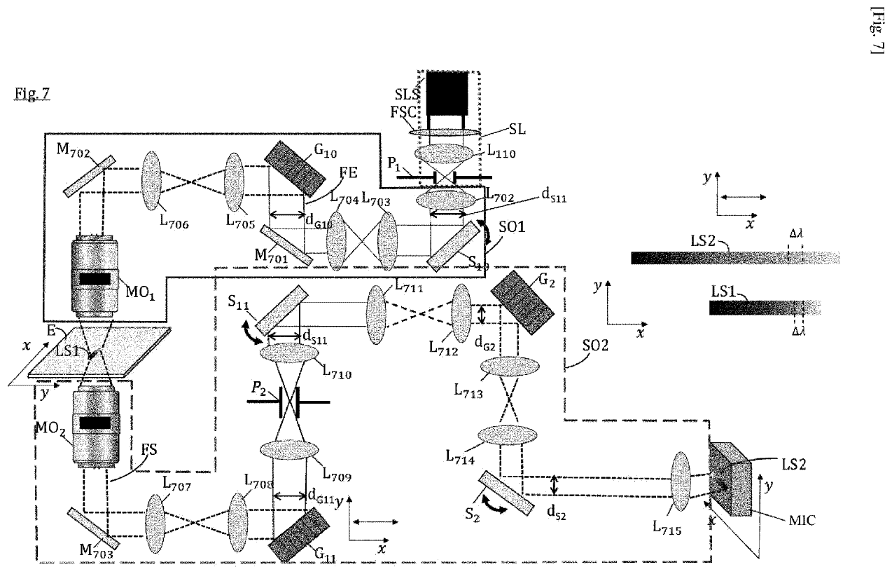

Such a system is shown in [FIG. 7]. Its operating principle is similar to that of [FIG. 3], except that it operates in transmission mode and not in reflection mode. In the same way, the embodiments shown in [FIG. 1], [FIG. 2], [FIG. 4] and [FIG. 5] can be modified for operating in transmission mode.

In the system shown in [FIG. 7], the light beam FE emitted by the source SL is collimated by the converging lens L₇₀₂ and reflected by the variable orientation mirror S₁₀ which scans it in direction y. After passing through an afocal system L₇₀₃-L₇₀₄ (note the absence of a pinhole, unnecessary in SO1) and being deflected by the (optional) mirror M₇₀₁, the beam FE is spectrally dispersed in direction x by the diffraction grating G₁₀, located in the Fourier plane of the pinhole P₁ of the source SL by virtue of said afocal system L₇₀₃-L₇₀₄ and the lens L₇₀₂. After passing through a second afocal system L₇₀₅-L₇₀₆ and being deflected once again by a mirror M₇₀₂ (also optional), the beam is focused by a first microscope objective lens MO₁ so as to form the spectral line LS1 on the sample E. The function of the afocal system L₇₀₆ L₇₀₅ is to optically conjugate the rear pupil of the microscope objective lens and the grating G₁. All these elements make up the first SO1 optical system.

The light that has passed through the sample (signal beam FS) is collected and collimated by a second microscope objective lens MO₂ located opposite the first, then spectrally recombined by another diffraction grating G₁₁ (note that these two gratings perform the dispersion and spectral recombination functions which, in the previously described embodiments, were performed by grating G₀ only). If DA₁₀ is the angular dispersion of G₁₀ and DA₁₁ that of G₁₁, we should ideally have M_{G10}-G₁₁ DA₁₁=DA₁₀ with M_{G10}-G₁₁ the magnification formed by L₇₀₅, L₇₀₆, MO₁, MO₂, L₇₀₇ and L₇₀₈, in other words the ratio between the diameter don of the optical beam on the grating G₁₁ and that (dG₁₀) on the grating G₁₀. The redirection mirror M₇₀₃ and the afocal system L₇₀₇-L₇₀₈ allow this grating to be optically conjugated with the rear pupil of MO₂. Equivalently, the system formed by L₇₀₅, L₇₀₆, MO₁, MO₂, L₇₀₇ and L₇₀₈ can be considered to optically conjugate G₁₀ and G₁₁ and the dispersion DA₁₀ imaged in the plane of G₁₁ is equal to DA₁₁. The spectrally recombined light beam is spatially filtered by the assembly L₇₀₉-P₂-L₇₁₀ and reaches the variable orientation mirror S₁₁, operated synchronously with S₁₀ and with an oscillation amplitude divided by the total magnification M_{S10-S11} between S₁₀ and S₁₁ (ratio between d_{S11}, diameter of the beam incident on S₁₁ and d_{S10}, diameter of the beam incident on S₁₀), so as to compensate for the angular scanning introduced by S₁₀ (as in the case of gratings G₁₀ and G₁₁, herein there are two variable orientation mirrors S₁₀ and S₁₁, which replace a single orientation mirror S₁ in the embodiments operating in reflection mode). Equivalently, S₁₀ and S₁₁ can be considered optically conjugate and the angular displacement of S₁₀ imaged in the plane of S₁₁ must be equal—or approximately equal—to the angular displacement of S₁₁. The beam FS is then spectrally dispersed by yet another diffraction grating G₂, with an angular dispersion DA₂ such that M_{G2}-G₁₁ DA₂/DA₁₁=A_{G}=2 (at least approximately), where M_{G2}-G₁₁ is herein the ratio between d_{G2} (diameter of the beam incident on G₂) and d₁₁. The spectrally re-dispersed beam is then reflected by another scanning mirror S₂ which is synchronized with S₁₀ and S₁₁ and has an oscillation amplitude approximately equal to 2A_{S2} M_{S10-S2}, with M_{S2} the magnification of the afocal system L₇₁₁, L₇₁₂, L₇₁₃, L₇₁₄ (in other words the ratio between d_{S2}, the diameter of the optical beam on the mirror S₂, and d_{S11}) and is focused by a lens L₇₁₅ so as to form a spectral line LS2 oriented in direction x and scanning the matrix image sensor CMI in direction y. Afocal systems L₇₁₁ L₇₁₂ and L₇₁₃-L₇₁₄ ensure optical conjugation between the various optical elements of the system SO2. Note that this system, which operates in transmission mode, has more components than the embodiments described hereinbefore, and requires the synchronization of three scanning mirrors. To alleviate these synchronization constraints, S₁₀, S₁₁ and S₁₂ can be replaced by a single scanning or oscillating system such as a resonant mirror or a polygon scanner.

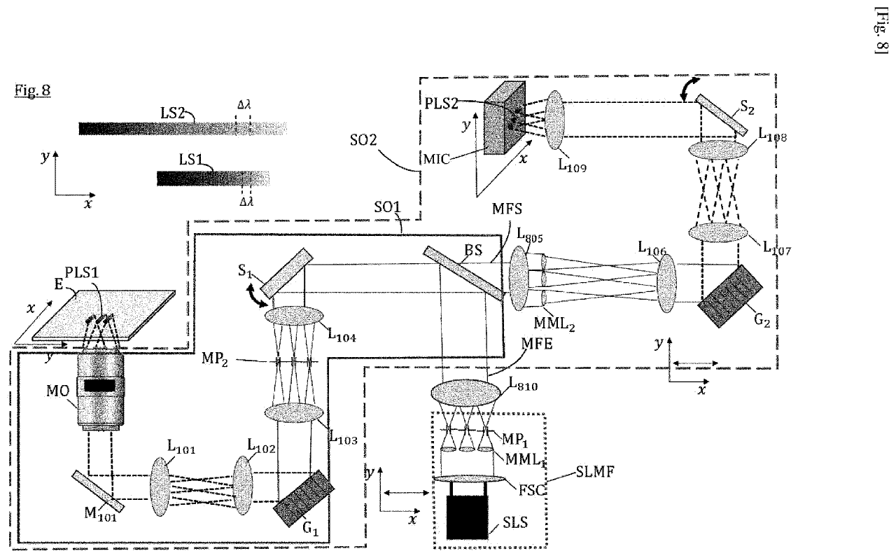

As explained hereinbefore, to reduce image acquisition time it is possible to accelerate the angular velocity of the scanning mirror(s), but this is technically difficult. An alternative approach, shown in [FIG. 8], consists of replacing a single light beam with a plurality of beams MFE arranged in direction y.

The embodiment shown in [FIG. 7] is similar to that shown in [FIG. 3], only the differences will be described in detail. Firstly, the light source SL is replaced by a source SLMF comprising a set of microlenses MML₁ aligned in direction y, decomposing the single light beam emitted by the broad-spectrum source SLS into the plurality of beams MFE. The spatial coherence of these beams is ensured by a plurality of pinholes MP₁ arranged in the focal plane of each microlens, replacing the single pinhole P₁. Similarly, the pinhole P₂ used for confocal filtering is replaced by a plurality of pinholes MP₂ aligned in direction y. Note that the lens L₁₀₅ of [FIG. 3] is replaced by a lens L₈₁₀ arranged at the output of the source SLMF to collimate the plurality of light beams MFE, as well as by a converging lens L₈₀₅ and a second plurality of microlenses aligned in direction y MML₂ focusing the plurality of signal beams MFS after the latter have passed through the beam splitter BS. In this system, N>1 spectral lines PLS1, PLS2 aligned in direction y (and oriented in direction x) are generated on the sample E and on the matrix image sensor, respectively. By virtue thereof, the same region of the sample can be imaged with the scanning mirrors S₁ and S₂, by performing an angular scan reduced by a factor N with respect to the case of a single spectral line. The time required to acquire an image of said region of the sample is therefore reduced by this same factor N.

The invention has been described with reference to a certain number of embodiments, but variants are possible. For example:
The optical beams need not necessarily be circular in cross-section. In this case, the notion of diameter must be replaced by that of transverse dimension. More specifically, the notion of beam diameter on a grating must be replaced by that of beam dimension in the dispersion direction (x, in the examples described hereinbefore) and the notion of beam diameter on a scanning mirror must be replaced by that of beam dimension in the scanning direction (y, in the examples described hereinbefore).
The internal structure of the light source SL is given as an example only; other structures are possible.
All or some of the converging lenses can be replaced by other optical elements such as concave mirrors or diffractive systems like holographic lenses, etc.
The diffraction gratings, or some thereof, can be replaced by other dispersive systems, for example three-dimensional diffractive structures, or even refractive systems such as prisms (except, in the case of the embodiment shown in [FIG. 6], which requires a diffractive system).
The microscope objective(s) can be replaced by other types of focusing system, for example concave mirrors or f-theta lenses. In this case, the dispersive elements will not necessarily be placed in a plane conjugate to a pupil of the focusing system but, more generally, in a plane conjugate to the Fourier plane of the sample
Directions x and y do not necessarily have to be perpendicular, although this is advantageous. They just have to be non-parallel.
In the embodiments wherein two scanning mirrors S₁, S₂ are carried by the same variable orientation structure, it is not necessary for them to be arranged on opposite faces of the structure.
The notion of a “variable orientation” mirror or support covers both resonant oscillating structures and structures whose orientation varies in a controlled manner, either continuously or in discrete steps.

### REFERENCES

(Sheppard 1988): C. J. R. Sheppard, “Super-resolution in Confocal Imaging”, Optik 80, No. 2, pages 53, 54.
(York 2013): A. G. York et al. “Instant super-resolution imaging in live cells and embryos via analog image processing,” Nat. Methods 2013 November, 10 (11), pages 1122-1126.
(De Luca 2013): G. M. R. De Luca “Re-scan confocal microscopy: scanning twice for better resolution” Biomedical Optics Express, Vol. 4, No. 11, November 2013.
(Curd 2015): A. Curd et al. “Construction of an instant structured illumination microscope”, Methods 88 (2015) pages 37 47.
(DuBose 2019): T. B. DuBose et al. “Super-resolution retinal imaging using optically reassigned scanning laser ophthalmology”, Nature Photonics, Vol. 13, April 2019, pages 257-262.
(Sandison 1995): D. R. Sandison et al. “Quantitative comparison of background rejection, signal-to-noise ratio, and resolution in confocal and full-field laser scanning microscopes” Applied Optics Vol. 34, No. 19, Jul. 1, 1995, pages 3576-3588.
(Aguilar 2020) Aguilar, A., Boyreau, A., Bon, P. “Label-free super-resolution imaging below 90-nm using photon-reassignment”. Open Research Europe, 1 (3), 3 (2021).
(Tearney 1998) G. J. Tearney et al. “Spectrally encoded confocal microscopy” Optics Letters, Vol. 23, No. 15, August 1998.
(Hwang 2015) Hwang J. et al. “Frequency and spectrally-encoded confocal microscopy” Optics Express, Vol. 23, No. 5, Mar. 9, 2015

1-15. (canceled)

16. A photon reallocation imaging system comprising:
a polychromatic light source (SL) configured to generate at least one spatially coherent illumination light beam (FE) over a range of illumination wavelengths;
a first optical system (SO1) configured to disperse said illumination light beam with a first angular dispersion DA₁ and to focus it on a sample (E) so as to form a first spectral line (LS1) oriented in a first direction (x);
a second optical system (SO2) configured to collect a light beam elastically scattered (FS) by said sample, referred to as signal beam, to apply thereto a second angular dispersion DA₂, and to focus it in a focal plane so as to form a second spectral line (LS2) oriented in a second direction (x);
a matrix image sensor (CMI) arranged in said image focal plane;
a means (PT, S₁) for inducing a relative displacement between the first spectral line and the sample in a third direction (y), perpendicular to the first direction; and
a means for forming an image of the sample through photon reallocation based on one or more images acquired by said matrix image sensor in correspondence with a plurality of different positions adopted by the first spectral line on the sample;
wherein the first optical system comprises a first dispersive optical device (G₁, G₁₀) for dispersing said illumination light beam with a first angular dispersion DA₁ and the second optical system comprises a second dispersive optical device (G₂) for applying to said illumination light beam with said second angular dispersion DA₂;
the length of the second spectral line in the second direction being greater than that of the first spectral line in the first direction by a factor A_{G}=M_{G}DA₂/DA₁>1, M_{G} being the ratio of the light beam size on the first dispersive optical device measured in the first direction to the signal beam size on the second dispersive optical device measured in the second direction.

17. The photon reallocation imaging system according to claim 16, wherein said factor A_{G} is between 1.8 and 2.2.

18. The photon reallocation imaging system according to claim 16, wherein the first optical system (SO1) comprises:
a first collimator system (L₁₀₅, L₂₀₅, L₃₀₅, L₄₀₅, L₅₀₅, L₆₀₅), configured to collimate said illumination light beam (FE);
said first dispersive optical device (G₁, G₁₀);
a focusing optical system (MO, MO1) configured to receive as input the illumination light beam dispersed by said first dispersive device and to focus it on the sample (E).

19. The photon reallocation imaging system according to claim 18, wherein the second optical system (SO2) comprises
said or another focusing system (MO, MO2) for collecting said signal beam,
collimating it and directing it to said first dispersive optical device, or another dispersive optical device, so that it is spectrally recombined;
said first (G₁) or said other (G₁₁) dispersive optical device, configured to spectrally recombine said signal beam;
said second dispersive optical device (G₂) having the second angular dispersion DA₂, for spectrally dispersing said signal beam in said second direction (x); and
at least one optical element (L₁₀₇, L₂₀₇, L₃₀₉, L₄₀₉, L₅₀₉, L₆₀₉) configured to focus in a focal plane, referred to as image focal plane, the signal beam spectrally dispersed by the second dispersive optical device (G₂).

20. The photon reallocation imaging system according to claim 19, wherein the second optical system comprises a pinhole (P₂) arranged in a plane conjugate with a focal plane of the focusing system of the second optical system (MO) so as to perform confocal filtering.

21. The photon reallocation imaging system according to claim 19, wherein the means for forming an image of the sample through photon reallocation based on a plurality of images of the second spectral line acquired by said matrix image sensor comprises a digital image processor (PNI).

22. The photon reallocation imaging system according to claim 21, wherein the means for inducing a relative displacement between the first spectral line and the sample comprises a sample translation stage (PT).

23. The photon reallocation imaging system according to claim 21, wherein the means for inducing a relative displacement between the first spectral line and the sample comprises a variable orientation mirror (S₁) common to the first and to the second optical system, configured to apply an angular scan in the third direction to the illumination light beam and an opposite angular scan to the spectrally recombined signal beam.

24. The photon reallocation imaging system according to claim 18, wherein:
the means for inducing a relative displacement between the first spectral line and the sample comprises a first variable orientation mirror (S₁) common to the first and to the second optical system, configured to apply an angular scan in the third direction to the illumination light beam and an opposite angular scan to the spectrally recombined signal beam; and
the means for forming an image of the sample through photon reallocation comprises a second variable orientation mirror (S₂), configured to apply an angular scan in a fourth direction, perpendicular to the second direction, to the signal beam spectrally dispersed by the second dispersive optical device;
the angular scan applied by the second variable orientation mirror being synchronous and having an amplitude equal to A_{S}/M_{S} times the amplitude of that applied by the first mirror, A_{S} being a factor between 1.8 and 2.2 and M_{S} being the ratio between the dimension of the illumination light beam on the second variable orientation mirror, measured in the fourth direction, and the dimension of the spectrally dispersed signal beam on the first variable orientation mirror, measured in the third direction.

25. The photon reallocation imaging system according to claim 24, wherein the first variable orientation mirror (S₁) is structurally independent of the second variable orientation mirror (S₂) and the first dispersive optical device (G₁) is separate from the second dispersive optical device (G₂).

26. The photon reallocation imaging system according to claim 16, wherein the first dispersive optical device (G₁) is a diffractive system exhibiting said angular dispersion DA₁ at the first diffraction order and said angular dispersion DA₂=2DA₁ at the second diffraction order, the second optical system being configured to collect the light scattered at the second diffraction order by said diffractive system.

27. The photon reallocation imaging system according to claim 24, wherein the first and the second variable orientation mirror are formed by two separate reflective regions of the same variable orientation support (SPO).

28. The photon reallocation imaging system according to claim 27, wherein said variable orientation support (SPO) is selected from a resonant mirror support and a polygon scanner.

29. The photon reallocation imaging system according to claim 27, wherein the first dispersive optical device (G1) is separate from the second dispersive optical device (G2).

30. The photon reallocation imaging system according to claim 16, wherein the light source (SLMF) comprises a first set of a plurality of microlenses (MML₁) aligned in the third direction (y) to generate a plurality of said illumination light beams in parallel, whereby said first optical system (SO1) forms on the sample (E) a plurality of first spectral lines (LS1) oriented in a first direction (x) and arranged in said third direction (y), and wherein said second optical system (SO2) comprises a second set of a plurality of microlenses (MML₂) aligned in said third direction (y) to form on the matrix image sensor (CMI) a plurality of first spectral lines (LS1) oriented in a first direction (x) and arranged in a fourth direction (y), perpendicular to said second direction (x).
